(19) United States
(12) Patent Application Publication
(10) Pub. No.: US 2007/0206742 A1
(43) Pub. Date: Sep. 6, 2007

(54) Advertising demographics reporting system

(76) Inventors: Thomas Nello Giaccherini, Carmel Valley, CA (US); John William Hayes, Reno, NV (US); George E. Hall, Granite Bay, CA (US)

Correspondence Address: Giaccherini, Post Office Box 1146, Carmel Valley, CA, 93924, US

(21) Appl. No.: 11/360,912

(22) Filed: Feb. 22, 2006

(51) Int. Cl. H04M 15/00

(52) U.S. Cl. 379/114.24

(57) ABSTRACT

The present invention comprises methods and apparatus for compiling and furnishing demographic data to advertisers based upon a plurality of promotions deployed during free phone calls.

### CROSS-REFERENCE TO A RELATED PATENT APPLICATION & CLAIMS FOR PRIORITY

The Present patent application is a related to Parent patent application U.S. Ser. No. 10/186,247, filed on 28 Jun. 2002. In accordance with the provisions of Section 119 & 120 of Title 35 of the United States Code of Laws, the Applicants hereby claim the benefit of priority for any subject matter that is shared by the Parent and the Present Application.

### FIELD OF THE INVENTION

The present invention pertains to methods and apparatus for supplying advertisers with verifiable, measured data concerning the actual deployment and customer receipt of their promotions. More particularly, one embodiment of the present invention provides a method for generating, analyzing and collecting demographic data for advertising and promotions that are deployed when customers place phone calls and listen to brief commercial messages.

### BACKGROUND OF THE INVENTION

Advertisers spend hundreds of billions of dollars each year to promote their products. Most forms of advertising are furnished by point-to-multi-point or broadcast methods. These kinds of communications involve the creation of hard copy or transmitted print, audio or images that are dispatched to consumers over one-way channels like newspapers, magazines, radio or television. In the past decade, advertising over the Internet has created a new class of ads which require the customer to click on a banner, but these ads do not provide much return information about a customer, and comprise an extremely small portion of the total advertising market.

None of these previous advertising methods offers a means for generating real-time information and demographic data about the deployment and actual reception of promotions. The development of such a system would constitute a major technological advance, and would satisfy long felt needs and aspirations in the advertising industry.

### SUMMARY OF THE INVENTION

The present invention comprises methods and apparatus for compiling and furnishing demographic data to advertisers based upon a plurality of promotions deployed during free phone calls.

In one embodiment of the invention, a caller initiates a call to a call recipient by lifting or activating a handset and dialing a special “dial-around” telephone number, such as 1.888.FREECALL. This dial-around or “10-10” number connects the caller to a particular long distance company, instead of the long distance company that normally provides long distance services. The caller is automatically connected to a Call Routing Server through the local telephone company. The Call Routing Server is connected to a Recorded Promotions Server, which plays a brief commercial message during the call. After the caller and/or call recipients listen to the commercial message, the Call Routing Server allows the conversation between the caller and call recipient to proceed. Additional ads may be deployed during the rest of the call.

In an alternative embodiment of the invention, calls may be routed over the Internet using VoIP methods and equipment.

An appreciation of the other aims and objectives of the present invention and a more complete and comprehensive understanding of this invention may be obtained by studying the following description of a preferred embodiment, and by referring to the accompanying drawings.

### A BRIEF DESCRIPTION OF THE DRAWINGS

FIG. 1 depicts a caller and a call recipient.

FIG. 2 portrays a print or television ad for placing a FreeCall^{SM}, which is viewed by the caller.

FIG. 3 shows the caller placing a FreeCall by dialing 1.888.FREECALL.

FIG. 4 reveals the caller as she listens to the FreeCall^{SM} greeting.

FIG. 5 shows the caller as she listens to a brief commercial message.

FIG. 6 depicts the free call between the caller and the recipient.

FIG. 7 shows additional ads being played during the later stages of the call.

FIG. 8 is a block diagram which shows one of the preferred embodiments of the network which may be utilized to implement the invention.

FIGS. 9 and 10 are examples of Advertising Deployment Reports which may be sold to advertisers.

FIGS. 11, 12, 13 and 14 furnish illustrations of alternative embodiments of the invention pertaining to market research, surveys and political polling.

### A DETAILED DESCRIPTION OF PREFERRED & ALTERNATIVE EMBODIMENTS

### I. Overview of the Invention

The present invention comprises methods and apparatus for enabling advertisers to determine exactly the persons who receive their promotions. In this Specification and in the Claims that follow, the terms “ad,” “advertising” and “promotion” encompass any message, sensation, data, signal, or audio or video recording, emanation or pattern of information that an advertiser furnishes for display or consumption by a consumer. An advertiser is any person, company or entity seeking to promote products or services. In an alternative embodiment, an advertiser may be a person, company, institution or organization that seeks to present information to others. This second class of advertisers may include political parties, candidates for office, charitable organizations or government agencies.

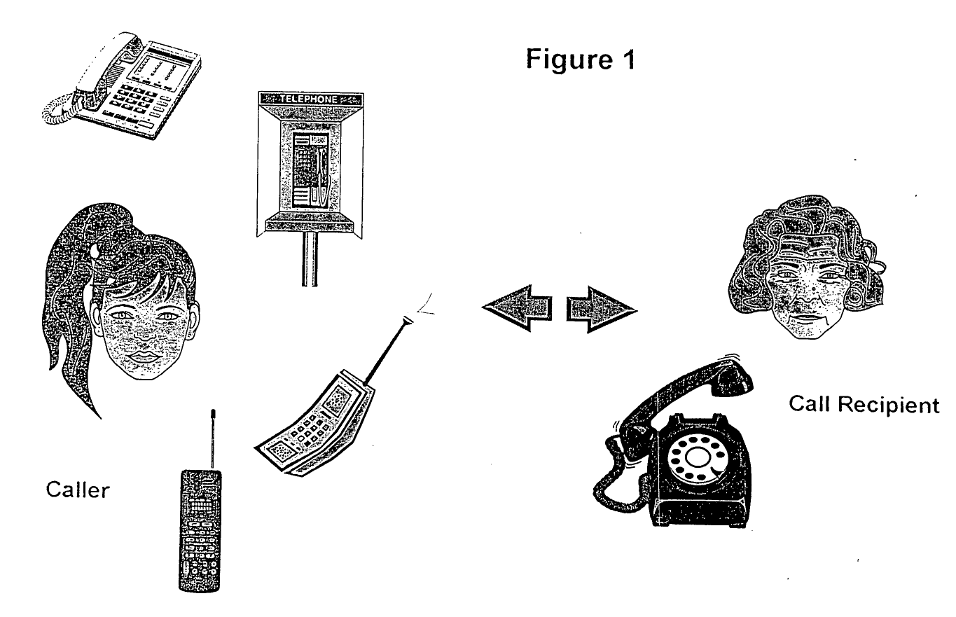

FIG. 1 illustrates a caller who wishes to place a phone call to a call recipient. She may use any type of phone, including a public phone, a fixed or cordless residential handset, or a cellphone. The call recipient is also free to use any type of phone as well. In this Specification and in the Claims that follow, a “call” is a communication or conveyance or information or data between a caller and callers and a recipient or recipients. The caller or the recipient may be persons or devices such a answering or recording machines, or voice recognition systems. A call may be established as a continuous and unbroken circuit between a caller and a recipient, or may be a virtual, changing connection that utilizes the transmission of digitized packets. A call may be a local, long distance or international call. If the call is a local call, both the caller's and the recipient's local phone company may be the same, and could be connected without a long distance carrier.

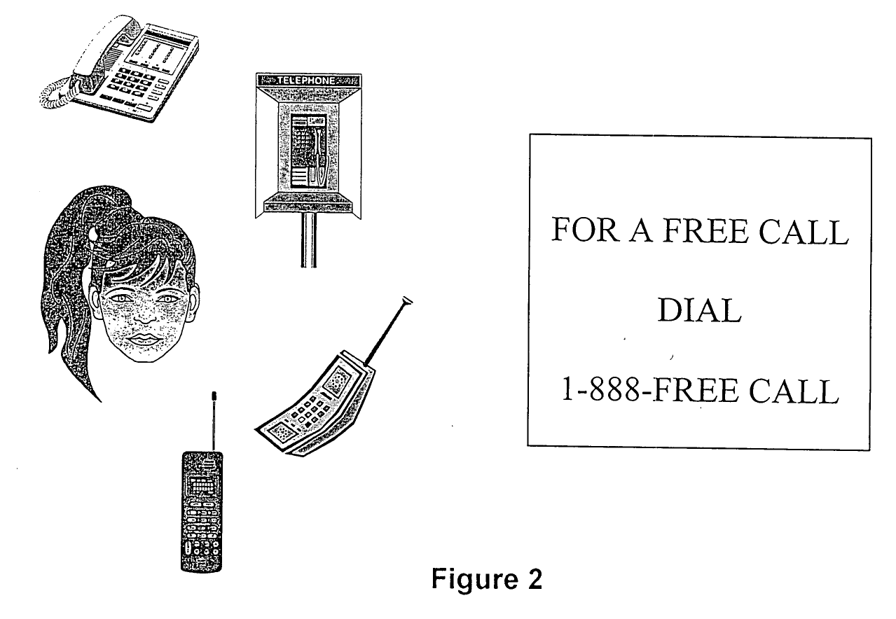

In FIG. 2, the caller sees a television or print-media advertisement for a new service, FreeCall^{SM}. FreeCall^{SM} is a Trade & Service Mark owned by the Assignee of this U.S. patent application.

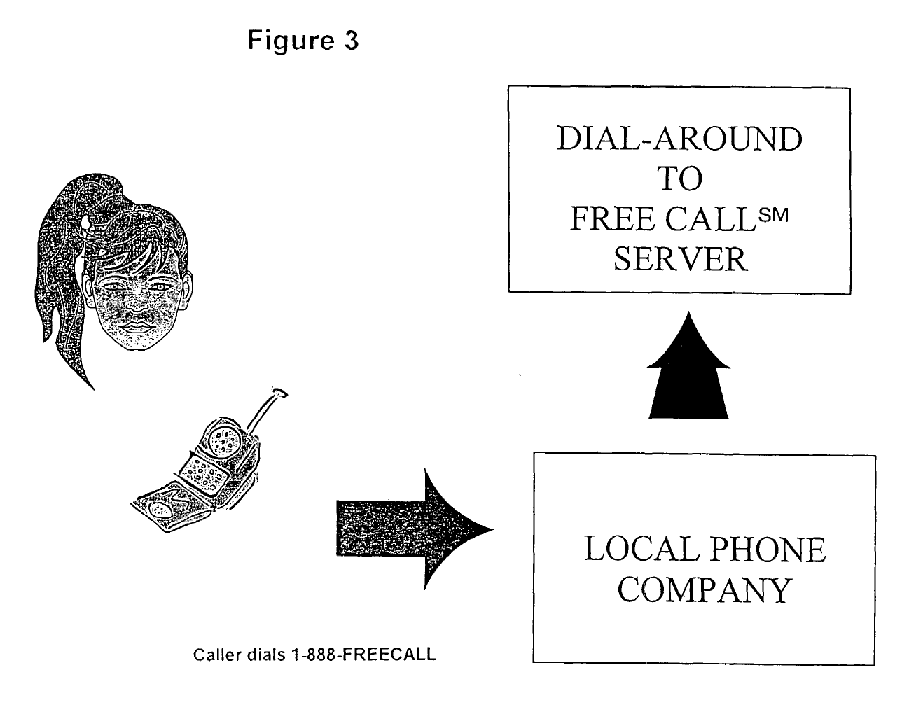

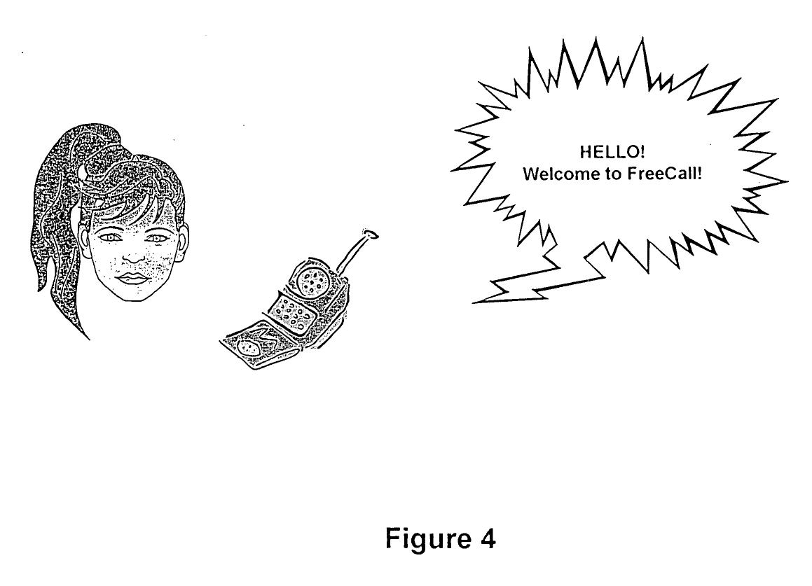

FIG. 3 shows the caller placing a FreeCall^{SM} by dialing 1-888-FREECALL, or some other suitable toll-free number. Dialing this number connects the caller first to the local telephone company that provides local service to the phone she is using, and then to the FreeCall^{SM} Call Server, which serves as the long distance carrier. In alternative embodiments, the Call Server may be connected to a separate long distance carrier, or the call may be switched directly from the local phone company to a dedicated separate long distance carrier. Example of local phone companies are Pacific Bell (SBC) and QWest (formerly US West). Examples of long distance carriers are AT&T, Sprint and MCI. These companies are also called “IXCs,” or inter-exchange carriers.

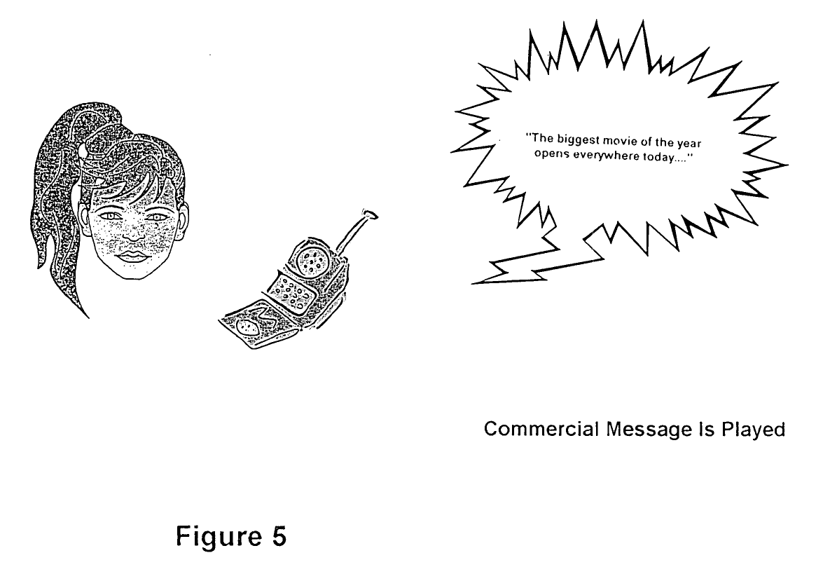

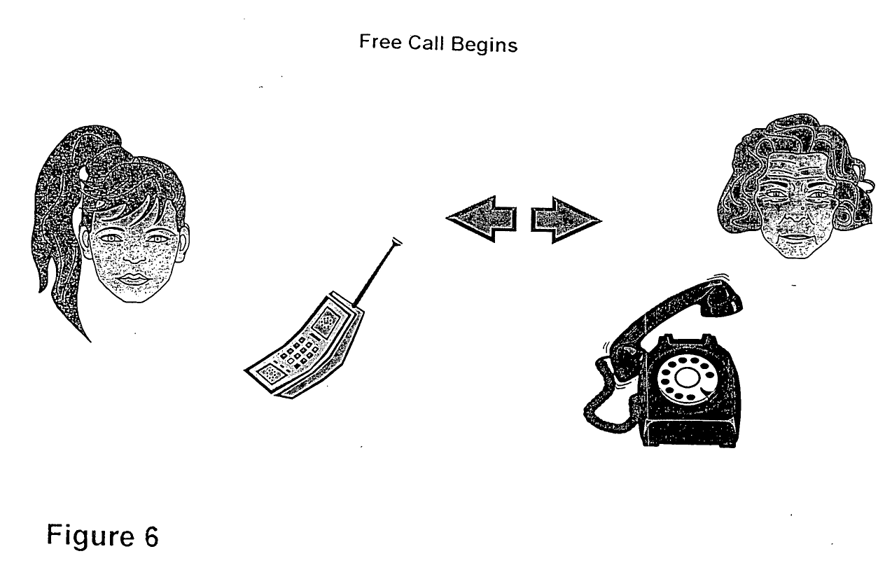

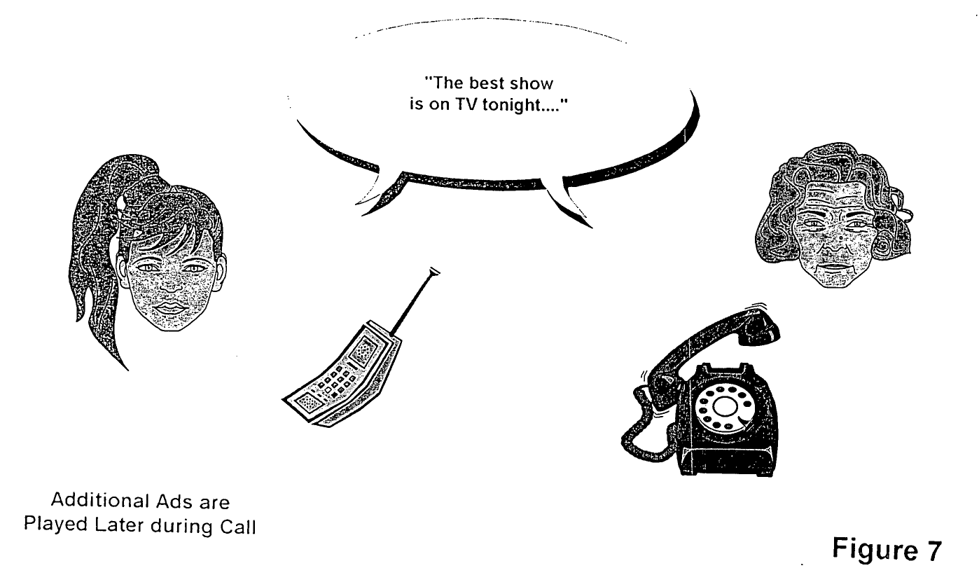

Once the call is connected to the Call Server, the caller hears a recorded greeting: “HELLO! Welcome to FreeCall!” The caller then listens to a brief commercial message, as depicted in FIG. 5. After the commercial message is played, the caller may be asked to answer a few brief questions, such as identifying gender or age group. Answers to these questions may be provided by using the keys on the telephone or by voice to a voice recognition system.

Once these preliminary tasks are completed, the call may be switched using an NNI, a network-to-network interface, to link the call to a recipient beyond the control area of the local exchange carrier to an IXC. The free call then begins between the caller and the recipient.

In an alternative embodiment of the invention, additional ads may be furnished during the remainder of the call. Either party or all parties may listen to the promotion.

### II. Implementation of the Invention

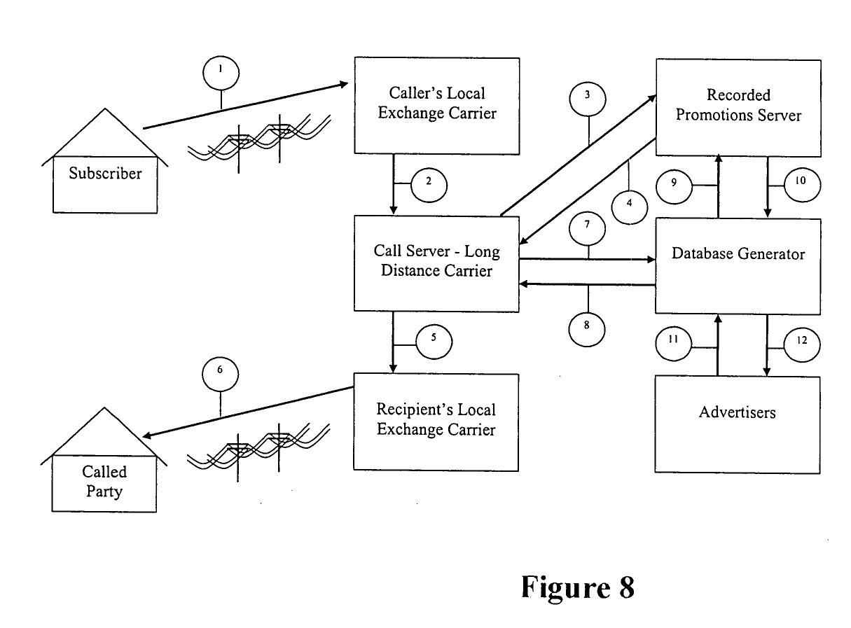

FIG. 8 is a block diagram which reveals a system that may be employed to practice one embodiment of the invention. A caller or subscriber is connected to a local phone company, which is also called a local exchange carrier or “LEC.” This connection is initiated when the caller activates his or her phone, and dials a special “dial-around” number. In the United States, these numbers are assigned by the federal government, and establish the connection between a local exchange carrier and a particular long distance provider. The caller need not know about the dial-around number, since the “888” number that he or she will dial will make the appropriate connection automatically.

As shown in FIG. 8, a first Local Exchange Carrier connects the call to the FreeCall^{SM} Call Server. The Call Server may be a long distance carrier, routing equipment at an Internet Service Provider, or a generic server running software that is capable of managing call traffic. The Call Server is connected to a Recorded Promotions Server. Either server may be co-located at the caller's local exchange carrier or at a long distance carrier or Internet Service Provider, or may reside at a remote location, including an offshore location. Recorded promotions are obtained from advertisers, and are played for callers during their free call. In one embodiment of the invention, the recorded promotions are played before the telephone conversation begins. The recorded promotions may be selected according to an advertiser's preferences, such as:
Time of Day
Gender
Age
Calling Location
Annual Income
Spending Habits
Marital Status
Occupation
Purchasing Preferences

Information such as time of day and calling location are obtained automatically from a clock and caller-id equipment. Other information such as the caller's gender or age may be obtained by requesting the caller to enter simple responses using the keys on his or her telephone. In an alternative embodiment, responses may be made by voice, and collected by suitable voice recognition equipment. The Recorded Promotions Server may offer a reward such as a discount, coupons or bonus if a caller provides demographic information. While most of the promotions are recorded, some could be delivered live, in real-time from a remote source.

In an alternative embodiment of the invention, software running on the Recorder Promotions Server may select a promotion to be played based on the demographic information received from the caller. Different ads may be played depending on the time of day, the caller's location, gender, age or other characteristic.

The call is established when the Call Server routes the call to the recipient's Local Exchange Carrier and then to the recipient's telephone.

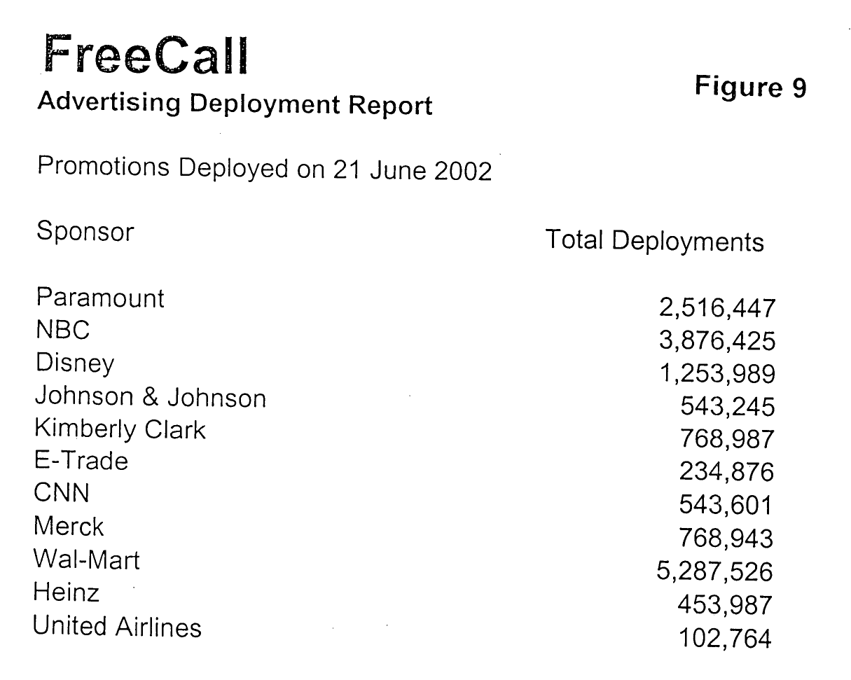

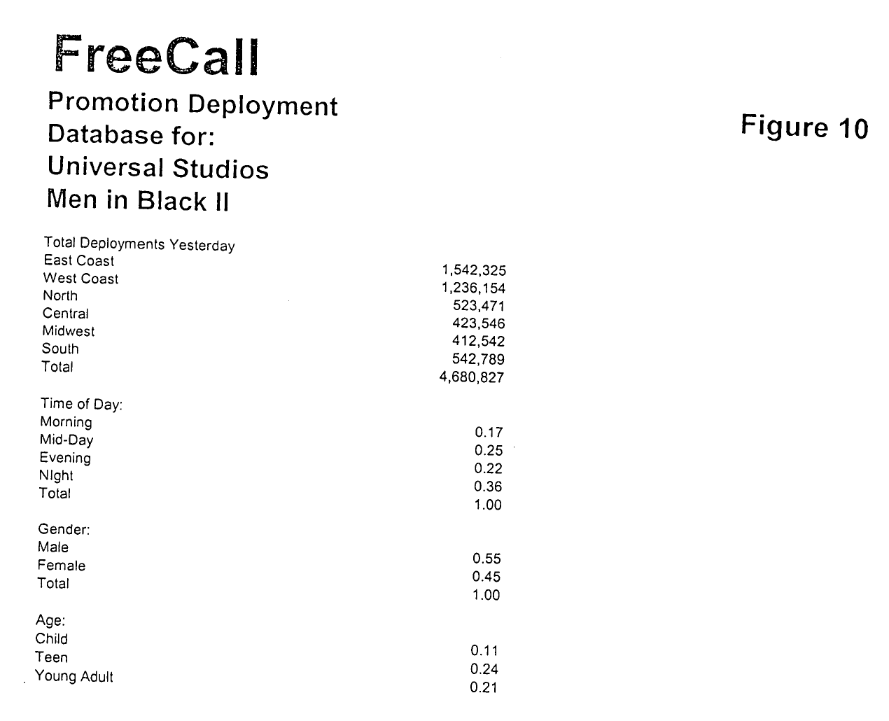

As shown in FIG. 9, a Database Generator produces an Advertising Deployment Report based on the deployed promotions. Examples of the information that may be reported are portrayed in FIGS. 9 and 10. Advertisers or sponsors pay a fee for this information. These reports may be supplied to advertisers periodically, or may be provided continuously in real-time as data is collected.

In an alternative embodiment of the invention, the caller's phone call may automatically initiate a connection to a local Internet Service Provider (ISP). The ISP then uses the phone number which he dialed to find another, remote Internet Service Provider somewhere on the Internet. The caller's voice is converted to a digital signal, and is routed via the first, and then to the second Internet Service Provider, where the digital signal is converted back to audio. This audio signal is conveyed to the intended recipient of the call when the second, remote Internet Service Provider places a local call to the recipient's ordinary telephone using the conventional local telephone system.

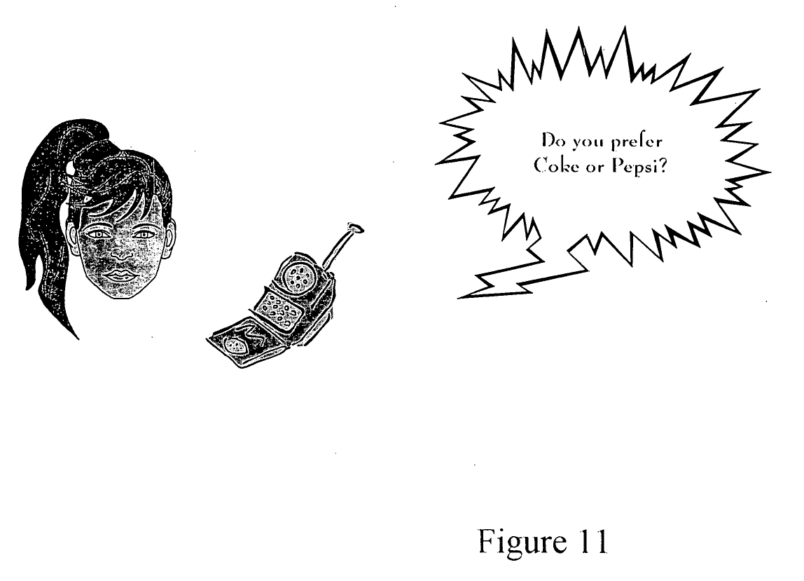

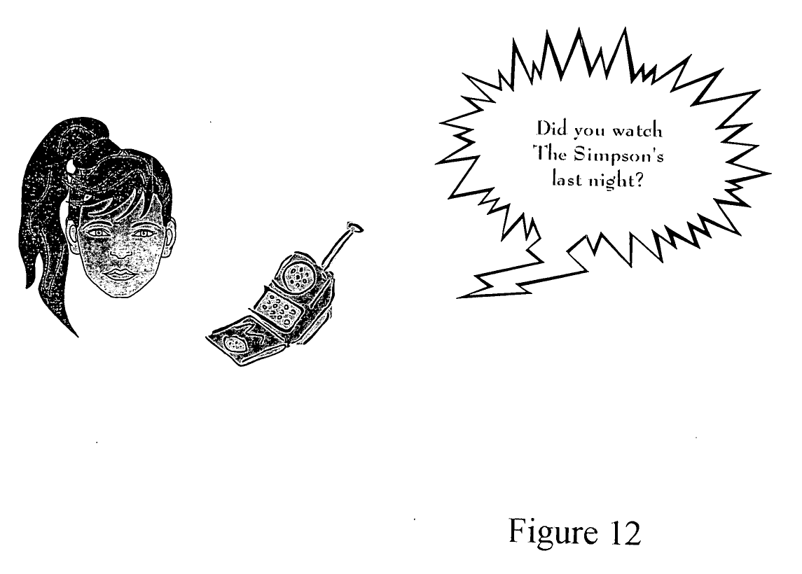

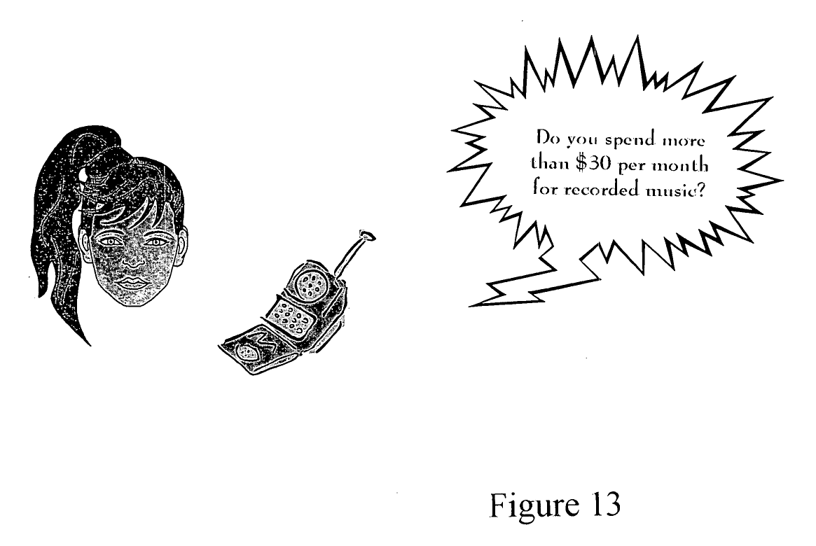

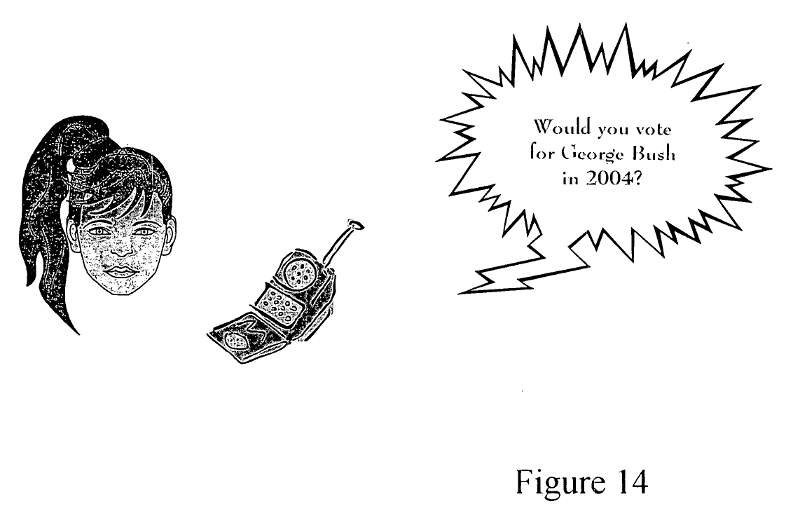

As shown in FIGS. 11, 12, 13, and 14 alternative embodiments of the invention may be utilized to provide political polling, surveys or marketing research.

Unlike conventional broadcast or print media advertising, which involves a one-way transmission of ads, the present invention furnishes an actual record of promotions that are deployed to customers. Unlike conventional advertising, where a sponsor is left to speculate about the whether an expensive broadcast or print campaign actually reaches its intended recipients, the present invention offers an empirically verifiable method of precise marketing processes.

### CONCLUSION

Although the present invention has been described in detail with reference to one or more preferred embodiments, persons possessing ordinary skill in the art to which this invention pertains will appreciate that various modifications and enhancements may be made without departing from the spirit and scope of the Claims that follow. The various alternatives for providing voice communications that have been disclosed above are intended to educate the reader about preferred embodiments of the invention, and are not intended to constrain the limits of the invention or the scope of Claims.

What is claimed is:

1. A method comprising the steps of:
initiating a call by dialing a toll-free telephone number from a caller's telephone;
automatically connecting said call to a call server means for routing calls via a dial-around means for directing said call to its intended recipient; said call server being connected to a recorded promotions server means for deploying an audio promotion;
playing said audio promotion; and
connecting said caller to a recipient's telephone.

2. A method as recited in claim 1, comprising the additional step of:
requesting demographic information from said caller.

3. A method as recited in claim 2, in which said demographic information comprises:
said caller's location.

4. A method as recited in claim 2, in which said demographic information comprises:
said caller's age.

5. A method as recited in claim 2, in which said demographic information comprises:
said caller's gender.

6. A method as recited in claim 2, in which said demographic information comprises:
said caller's annual income.

7. A method as recited in claim 2, in which said demographic information comprises:
said caller's spending habits.

8. A method as recited in claim 2, in which said demographic information comprises:
said caller's marital status.

9. A method as recited in claim 2, in which said demographic information comprises:
said caller's occupation.

10. A method as recited in claim 1, comprising the additional step of:
recording a response from said caller as a result of requesting demographic information from said caller.

11. A method as recited in claim 10, comprising the additional step of:
providing a reward to said caller for supplying demographic information.

12. A method as recited in claim 1, comprising the additional step of:
producing demographic information about said call automatically.

13. A method as recited in claim 12, in which said demographic information includes the time of day of the call reckoned by a clock at said recorded promotions server means.

14. A method as recited in claim 12, in which said demographic information includes the location of the call determined by caller-id equipment located at said recorded promotions server means.

15. A method as recited in claim 12, comprising the additional step of:
selecting an audio promotion for deployment during a call based on said demographic information obtained from said caller.

16. A method as recited in claim 1, in which said call is a local call.

17. A method as recited in claim 1, in which said call is a long distance call.

18. A method as recited in claim 1, in which said call is an international call.

19. A method as recited in claim 1, in which both said caller and said recipient participate in said call without charge.

20. A method as recited in claim 1, in which said call is first connected from said caller's telephone to a caller's local exchange carrier.

21. A method as recited in claim 20, in which said call server means is co-located with said caller's local exchange carrier.

22. A method as recited in claim 20, in which said call server means is located remotely from said caller's local exchange carrier.

23. A method as recited in claim 20, in which said call server means is located offshore.

24. A method as recited in claim 20, in which said recorded promotions server means is co-located with said caller's local exchange carrier.

25. A method as recited in claim 20, in which said recorded promotions server means is located remotely from said caller's local exchange carrier.

26. A method as recited in claim 20, in which said recorded promotions server means is located offshore.

27. A method as recited in claim 10, in which said responses are provided using a telephone key pad.

28. A method as recited in claim 10, in which said responses are provided by voice and are collected using a voice recognition device.

29. A method as recited in claim 10, in which said responses are provided to advertisers in real-time as they are collected.

30. A method as recited in claim 1, comprising the additional step of:
recording a response from said caller as a result of requesting information from said caller concerning market research.

31. A method as recited in claim 1, comprising the additional step of:
recording a response from said caller as a result of requesting information from said caller concerning a survey.

32. A method as recited in claim 1, comprising the additional step of:
recording a response from said caller as a result of requesting information from said caller concerning political polling.

33. A method comprising the steps of:
obtaining a dial-around number;
linking said dial-around number to a toll-free number;
contracting with a local exchange carrier for service;
contracting with an inter-exchange carrier for service;
linking said local exchange carrier with a recorded promotions server;
obtaining promotion from an advertiser and storing said promotion on said recorded promotions server;
providing toll-free calls to callers and recipients;
generating an advertising deployment database; and
furnishing said advertising deployment database to an advertiser for compensation.

34. A propagated signal comprising:
providing a plurality of connections among a plurality of callers and a plurality of call recipients;
deploying a promotion signal to some of said callers and some of said recipients;
generating a database reporting the deployments of said promotion signals for an advertiser.
